(19) United States
(12) Patent Application Publication
(10) Pub. No.: US 2012/0112037 A1
(43) Pub. Date: May 10, 2012

(54) THREE-DIMENSIONAL IMAGING DEVICE

(75) Inventors: Masao Hiramoto, Osaka (JP); Masayuki Misaki, Hyogo (JP); Teruyuki Takazawa, Osaka (JP); Masaaki Suzuki, Osaka (JP)

(73) Assignee: PANASONIC CORPORATION, Osaka (JP)

(21) Appl. No.: 13/382,183

(22) PCT Filed: Feb. 10, 2011
(86) PCT No.: PCT/JP2011/000762

§ 371 Date: Jan. 4, 2012

(30) Foreign Application Priority Data
May 11, 2010 (JP) 2010-109654

(51) Int. Cl. H01J 40/14

(52) U.S. Cl. 250/206

(57) ABSTRACT

An image capture device according to the present invention includes an imaging lens 3, a light-transmitting section 2 with two polarizers, a rotation driving section 2A that rotates the light transmitting section 2, and a solid-state image sensor 1 that has multiple pixels and their associated polarization filters. A first polarization filter 50a is arranged to face a first group of pixels W1 and a second polarization filter 50b is arranged to face a second group of pixels W2. The respective transmission axes of the polarizing areas P(1) and P(2) of the light-transmitting section 2 form an angle α between themselves. Also, the respective transmission axes of the polarization filters 50a and 50b form an angle β between themselves. And the rotation driving section 2A can rotate the light-transmitting plate 2 on the optical axis. As a result, multiple sets of multi-viewpoint images can be obtained.

### TECHNICAL FIELD

The present invention relates to a single-lens 3D image capturing technology for capturing multiple images with parallax by using one optical system and one image sensor.

### BACKGROUND ART

Recently, the performance and functionality of digital cameras and digital movie cameras that use some image sensor such as a CCD and a CMOS have been enhanced to an astonishing degree. In particular, the size of a pixel structure for use in an image sensor has been further reduced these days thanks to rapid development of semiconductor device processing technologies, thus getting an even greater number of pixels and drivers integrated together in an image sensor. As a result, the resolution of an image sensor has lately increased rapidly from one million pixels to ten million or more pixels in a matter of few years. On top of that, the quality of an image captured has also been improved significantly as well. As for display devices, on the other hand, LCD and plasma displays with a reduced depth now provide high-resolution and high-contrast images, thus realizing high performance without taking up too much space. And such video quality improvement trends are now spreading from 2D images to 3D images. In fact, 3D display devices that achieve high image quality although they require the viewer to wear a pair of polarization glasses have been developed just recently and put on the market one after another.

As for the 3D image capturing technology, a typical 3D image capture device with a simple arrangement uses an image capturing system with two cameras to capture a right-eye image and a left-eye image. According to the so-called “two-lens image capturing” technique, however, two cameras need to be used, thus increasing not only the overall size of the image capture device but also the manufacturing cost as well. To overcome such a problem, methods that use a single camera for the same purpose have been researched and developed. For example, Patent Document No. 1 discloses a scheme that uses two polarizers, of which the polarization directions intersect with each other at right angles, and a rotating polarization filter. FIG. 10 illustrates an arrangement for an image capturing system that adopts such a scheme.

The image capturing system shown in FIG. 10 includes a 0-degree-polarization polarizer 11, a 90-degree-polarization polarizer 12, a reflective mirror 13, a half mirror 14, a circular polarization filter 15, a driver 16 that rotates the circular polarization filter 15, an optical lens 3, and an image capture device 9 for capturing the image that has been produced by the optical lens. In this arrangement, the half mirror 14 transmits the light that has been transmitted through the polarizer 12 but reflects the light that has been transmitted through the polarizer 11 and then reflected from the reflective mirror 13.

With such an arrangement, the incoming light rays are transmitted through the two polarizers 11 and 12 that are arranged at two different positions, have their optical axes aligned with each other by the reflective mirror and the half mirror, pass through the circular polarization filter and the optical lens and then enter the image capture device, where an image is captured. The image capturing principle of this scheme is that two images with parallax are captured by rotating the circular polarization filter so that the light rays that have entered the two polarizers are imaged at mutually different times.

According to such a scheme, however, images at mutually different positions are captured time-sequentially by rotating the circular polarization filter, and therefore, those images with parallax cannot be captured at the same time, which is a problem. In addition, the durability of such a system is also a question mark because the system uses mechanical driving. On top of that, since all of the incoming light is received by the polarizers and the polarization filter, the quantity of the light received eventually by the image capture device 9 decreases by as much as 50%, which is non-negligible, either.

To overcome these problems, Patent Document No. 2 discloses a scheme for capturing two images with parallax without using such mechanical driving. According to such a scheme, incoming light rays are received in two separate areas and then the light rays that have come from those areas are condensed onto a single image sensor to capture an image there, but no mechanical driving section is used. Hereinafter, its image capturing principle will be described with reference to FIG. 11, which illustrates an arrangement for an image capturing system that adopts such a scheme. The image capturing system shown in FIG. 11 includes two polarizers 11 and 12, of which the polarization directions intersect with each other at right angles, reflective mirrors 13, an optical lens 3, and an image sensor 1. The image sensor 1 has a number of pixels 10 and polarization filters 17 and 18, each of which is provided one to one for an associated one of the pixels 10. The polarization filters 17 and 18 have the same property as the polarizers 11 and 12, respectively. And those polarization filters 17 and 18 are arranged alternately over all of those pixels.

With such an arrangement, the incoming light rays are transmitted through the polarizers 11 and 12, reflected from the reflective mirrors 13, passed through the optical lens 3 and then imaged by the image sensor 1. The light rays that have come after having been transmitted through the polarizers 11 and 12 are passed through the polarization filters 17 and 18 and then photoelectrically converted by the pixels that face those polarization filters 17 and 18, respectively. If the images to be produced by those incoming light rays that have been transmitted through the polarizers 11 and 12 are called a “right-eye image” and a “left-eye image”, respectively, then the right-eye image and the left-eye images are generated by a group of pixels that face the polarization filters 17 and a group of pixels that face the polarization filter 18, respectively, after having been transmitted through the polarization filters 17 and 18.

As can be seen, according to the scheme disclosed in Patent Document No. 2, two polarization filters with mutually different properties are arranged alternately over the pixels of the image sensor, instead of using the circular polarization filter disclosed in Patent Document No. 1. As a result, although the resolution decreases to a half compared to the method of Patent Document No. 1, a right-eye image and a left-eye image can still be obtained at the same time.

According to such a technique, although two images with parallax can be certainly obtained by using a single image sensor, the incoming light has its quantity decreased considerably when being transmitted through the polarizers and then the polarization filters, and therefore, the resultant image comes to have significantly decreased sensitivity.

As another approach to the problem that the resultant image has decreased sensitivity, Patent Document No. 3 discloses a technique for mechanically changing the modes of operation from the mode of capturing two images that have parallax into the mode of capturing a normal image, and vice versa. Hereinafter, its image capturing principle will be described with reference to FIG. 12, which illustrates an arrangement for an image capturing system that uses such a technique. The image capture device shown in FIG. 12 includes a light transmitting member 19 that has two polarized light transmitting portions 20 and 21 and that transmits the light that has come from an optical lens 3 only through those transmitting portions, a light receiving member optical filter tray 22 in which particular component transmitting filters 23 that split the light that has come from the polarized light transmitting portions 20 and 21 and color filters 24 are arranged as a set, and a filter driving section 25 that removes the light transmitting member 19 and the particular component transmitting filters 23 from the optical path and inserts the color filters 24 onto the optical path instead, and vice versa.

According to this technique, by running the filter driving section, the light transmitting member and the particular component transmitting filters are used to capture two images with parallax, while the color filters are used to capture a normal image. However, the two images with parallax are shot in basically the same way as in Patent Document No. 2, and therefore, the resultant image comes to have a significantly decreased sensitivity. When a normal color image is shot, on the other hand, the light transmitting member is removed from the optical path and the color filters are inserted instead of the particular component transmitting filters. As a result, a color image can be generated without decreasing the sensitivity.

### CITATION LIST

### Patent Literature

Patent Document No. 1: Japanese Patent Application Laid-Open Publication No. 62-291292
Patent Document No. 2: Japanese Patent Application Laid-Open Publication No. 62-217790
Patent Document No. 3: Japanese Patent Application Laid-Open Publication No. 2001-016611

### SUMMARY OF INVENTION

### Technical Problem

According to the conventional techniques, two images can be certainly captured with a single-lens camera, but each of those two images eventually has decreased sensitivity. Also, in order to obtain more parallax information from the same subject and thereby increase the accuracy of the subject's depth information, images should be captured by either shifting the camera or rotating the camera itself. In any case, some mechanism for moving the camera should be used.

It is therefore an object of the present invention to provide an image capturing technique that uses any such mechanism for moving the camera itself and yet can obtain more parallax information than what can be obtained from the two images with parallax. In the following description, such images with parallax will be referred to herein as “multi-viewpoint images”.

### Solution to Problem

A 3D image capture device according to the present invention includes: a light transmitting section with at least two polarizers; a solid-state image sensor that receives the light ray that has been transmitted through the light transmitting section; an imaging section that produces an image on an imaging area of the solid-state image sensor; and a rotation driving section that rotates the light transmitting section on the optical axis of incoming light. The light transmitting section includes a first polarizer, and a second polarizer, of which the transmission axis defines an angle α (where 0 degrees<α≦90 degrees) with respect to the transmission axis of the first polarizer. The solid-state image sensor includes a number of pixel blocks, each of which includes first and second pixels, a first polarization filter that is arranged to face the first pixel of each pixel block, and a second polarization filter that is arranged to face the second pixel of each pixel block and of which the transmission axis defines an angle β (where 0 degrees<β≦90 degrees) with respect to the transmission axis of the first polarization filter. The first polarization filter is arranged so as to receive the light rays that have been transmitted through the first and second polarizers. And the second polarization filter is also arranged so as to receive the light rays that have been transmitted through the first and second polarizers.

In one preferred embodiment, the light transmitting section has a transparent area that always transmits incoming light irrespective of its polarization direction. Each pixel block further has a third pixel. The third pixel receives the light rays that have been transmitted through the first and second polarizers and the transparent area, respectively, and outputs a photoelectrically converted signal representing the quantity of the light received.

In this particular preferred embodiment, if a transmittance when non-polarized light is incident on the first and second polarizers and the first and second polarization filters is T1 and if a transmittance when polarized light that oscillates along the transmission axis of the first polarization filter is incident on the first polarization filter and a transmittance when polarized light that oscillates along the transmission axis of the second polarization filter is incident on the second polarization filter are T2, and if the angle defined by the transmission axis of the first polarizer with respect to the transmission axis of the first polarization filter is φ, then the angle of rotation of the light transmitting section is set such that the value of the determinant

$$\vert D \vert = \vert \begin{matrix}T 2 \vert cos φ \vert - T 1 & T 2 \vert cos ( φ + α ) \vert - T 1 \\ T 2 \vert cos ( φ - β ) \vert - T 1 & T 2 \vert cos ( φ + α - β ) \vert - T 1\end{matrix} \vert$$

does not become equal to zero.

In a specific preferred embodiment, the inequality

cos(α/2)cos(β/2)>T1/T2

is satisfied, and φ is defined to fall within one of the three ranges of: 0≦φ<π/2−α, π/2+β<φ<3π/2−α, and 3π/2−β<φ<2π.

In a specific preferred embodiment, 80 degrees≦α≦90 degrees is satisfied.

In another preferred embodiment, each pixel block further includes a fourth pixel, and the solid-state image sensor includes a first color filter that is arranged so as to face the third pixel of each pixel block and to transmit a light ray representing a first color component, and a second color filter that is arranged so as to face the fourth pixel of each pixel block and to transmit a light ray representing a second color component.

In this particular preferred embodiment, in each pixel block, the first, second, third and fourth pixels are arranged in matrix, in which the first pixel is arranged at a row 1, column 1 position, the second pixel is arranged at a row 2, column 2 position, the third pixel is arranged at a row 1, column 2 position, and the fourth pixel is arranged at a row 2, column 1 position.

In another preferred embodiment, one of the first and second color filters transmits a light ray representing a yellow component, while the other color filter transmits a light ray representing a cyan component.

In still another preferred embodiment, if the angle defined by the transmission axis of the first polarizer with respect to the transmission axis of the first polarization filter is φ, the device captures an image in each of a first state in which φ=φ1 (where 0 degrees≦φ1<360 degrees) and a second state in which φ=φ1+180 degrees.

In yet another preferred embodiment, the 3D image capture device further includes an image processing section that generates an image representing the difference between two images with parallax using photoelectrically converted signals supplied from the first and second pixels.

An image generating method according to the present invention is designed to be used in the 3D image capture device of the present invention and includes the steps of: getting a first photoelectrically converted signal from the first pixel; getting a second photoelectrically converted signal from the second pixel; and generating an image representing the difference between two images with parallax based on the first and second photoelectrically converted signals.

### Advantageous Effects of Invention

In the 3D image capture device of the present invention, its light incident area has at least two polarizing areas, and its image sensor has at least two kinds of pixel groups, for each of which a polarization filter is provided. Thus, the images produced by two light rays that have come from mutually different light incident areas can be captured by the two kinds of pixel groups that is equivalent to getting two different pieces of incident light information with two sensors having mutually different properties. That is why the relation between two inputs and their associated outputs can be represented by a particular mathematical equation. Stated otherwise, the two inputs can be derived from the two outputs by making calculations. Consequently, by getting image information from the two polarizing areas and subjecting the image information to differential processing, information about the difference between multi-viewpoint images can be obtained. In addition, the 3D image capture device of the present invention includes a rotation driving section that rotates the light incident area, and therefore, can capture an image with the polarizing areas to use changed. As a result, subject's depth information can be obtained from multiple different viewpoints that contributes to increasing the accuracy of the subject's depth information.

### BRIEF DESCRIPTION OF DRAWINGS

FIG. 1 illustrates an overall arrangement for an image capture device as a first preferred embodiment of the present invention.

FIG. 2 schematically illustrates how light is incident on the solid-state image sensor of the first preferred embodiment of the present invention.

FIG. 3 is a front view illustrating the light-transmitting plate of the first preferred embodiment of the present invention.

FIG. 4 illustrates a basic arrangement of pixels in the image capturing section of a solid-state image sensor according to the first preferred embodiment of the present invention.

FIG. 5 shows how much a |D| value depends on the angle φ of rotation in the first preferred embodiment of the present invention.

FIG. 6 illustrates a basic color scheme for the image capturing section of a solid-state image sensor according to a second preferred embodiment of the present invention.

FIG. 7 shows how much a |D| value depends on the angle φ of rotation in the second preferred embodiment of the present invention.

FIG. 8 illustrates a basic arrangement of pixels in another solid-state image sensor according to the first preferred embodiment of the present invention.

FIG. 9 is a front view illustrating another light-transmitting plate according to the first preferred embodiment of the present invention.

FIG. 10 illustrates an arrangement for an image capturing system according to Patent Document No. 1.

FIG. 11 illustrates an arrangement for an image capturing system according to Patent Document No. 2.

FIG. 12 illustrates an arrangement for an image capturing system according to Patent Document No. 3.

### DESCRIPTION OF EMBODIMENTS

Hereinafter, preferred embodiments of the present invention will be described with reference to the accompanying drawings. In the following description, any element shown in multiple drawings and having substantially the same function will be identified by the same reference numeral.

### Embodiment 1

FIG. 1 illustrates an arrangement for an image capture device as a first preferred embodiment of the present invention. As shown in FIG. 1, the image capture device includes: a solid-state image sensor 1 that performs photoelectric conversion; a light-transmitting plate 2 with some polarizing areas; a rotation driving section 2A that rotates the light-transmitting plate 2 on the optical axis; a circular optical lens 3 that images incoming light; an infrared cut filter 4; a signal generating and image signal receiving section 5, which not only generates a fundamental signal to drive the solid-state image sensor but also receives a signal from the solid-state image sensor; an image sensor driving section 6 for generating a signal to drive the solid-state image sensor; an image processing section 7, which processes the image signal to generate multi-viewpoint images, a differential image representing the difference between the multi-viewpoint images, and an ordinary image that has no parallax and good enough sensitivity; and an image interface section 8, which outputs image signals representing the multi-viewpoint images, differential image and ordinary image thus generated to an external device. In the following description, the multi-viewpoint images and the differential image will sometimes be collectively referred to herein as “images with parallax”.

The light-transmitting plate 2 has polarizing areas in which two polarizers are arranged and a transparent area, which always transmits the incoming light irrespective of its polarization direction. The solid-state image sensor 1 (which will sometimes be simply referred to herein as an “image sensor”) is typically a CCD or CMOS sensor, which may be fabricated by known semiconductor device processing technologies. On the imaging area of the solid-state image sensor 1, arranged two-dimensionally are a number of pixels (i.e., photosensitive cells). Each pixel is typically a photodiode, which makes a photoelectric conversion and outputs a photoelectrically converted signal (that is an electrical signal representing the quantity of the light received). The image processing section 7 includes a memory that stores various kinds of information for use to perform image processing and an image signal generating section for generating an image signal on a pixel-by-pixel basis based on the data that has been retrieved from the memory.

With such an arrangement, the incoming light is transmitted through the light-transmitting plate 2, the optical lens 3 and the infrared cut filter 4, imaged on the imaging area of the solid-state image sensor 1, and then photoelectrically converted by the solid-state image sensor 1. An image signal generated as a result of the photoelectric conversion is sent through the image signal receiving section 5 to the image processing section 7, where the multi-viewpoint images, the differential image and the ordinary image that has no parallax and good enough sensitivity are generated. By rotating the light-transmitting plate 2 using the rotation driving section 2A, the two polarizing areas of the light-transmitting plate 2 can change their positions. The rotation driving section 2A operates in accordance with an instruction that has been received from the signal generating and image signal receiving section 5 by way of the sensor driving section 6.

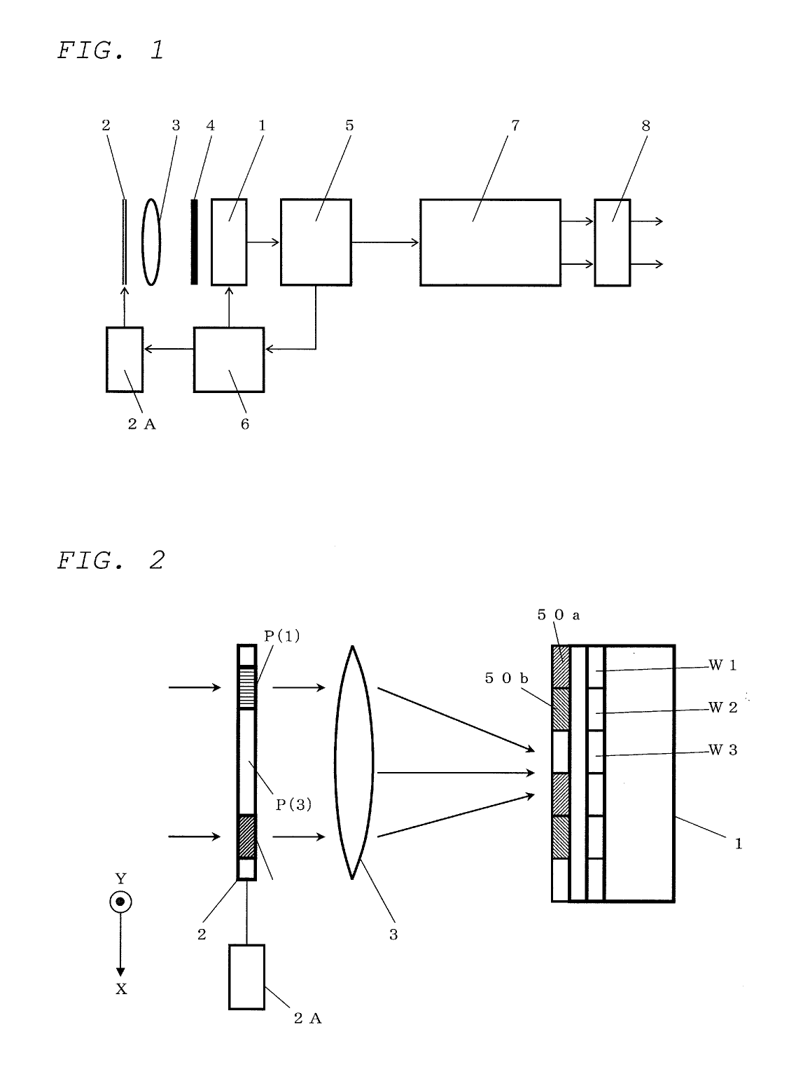

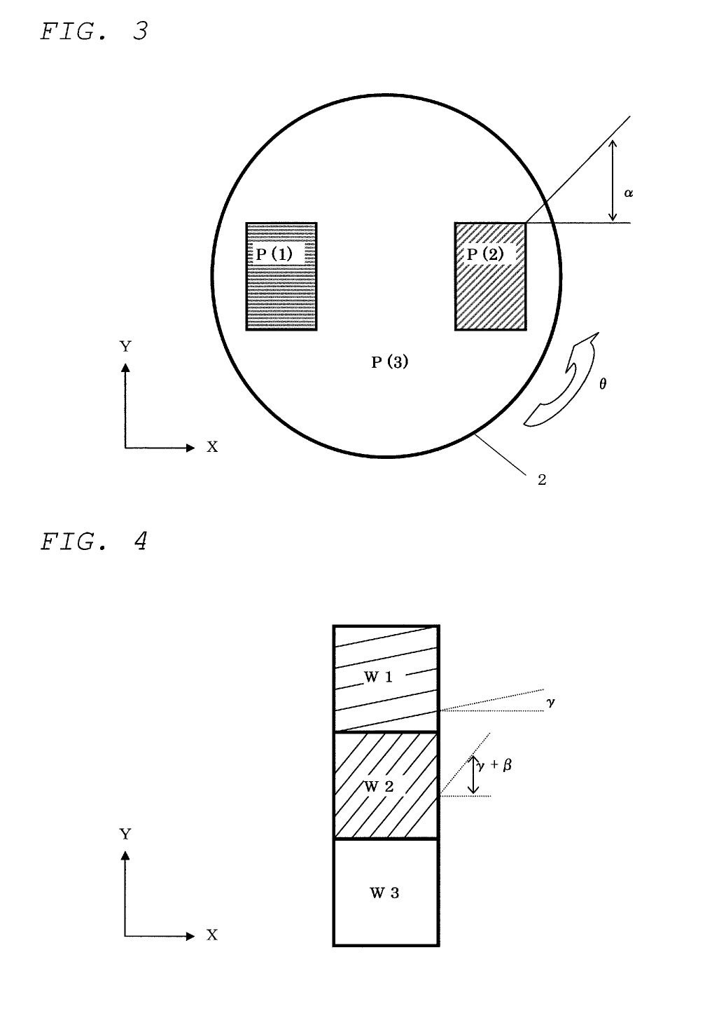

FIG. 2 schematically illustrates how the incoming light is transmitted through the light-transmitting plate 2 and the optical lens 3 and then incident on the imaging area of the solid-state image sensor 1. It should be noted that in FIG. 2, only the light-transmitting plate 2, the optical lens 3, the solid-state image sensor 1 and the rotation driving section 2A are illustrated but the other members are not illustrated. Also, as for the solid-state image sensor 1, only a part of its imaging area is illustrated in FIG. 2. As shown in FIG. 2, the light-transmitting plate 2 has two polarizing areas P(1) and P(2) and a transparent area P(3). In this case, these polarizing areas P(1) and P(2) have mutually different transmission axis directions. Meanwhile, multiple pixels that are arranged on the imaging area of the solid-state image sensor 1 form a number of pixel blocks, each of which consists of three pixels (which will be identified herein by W1, W2 and W3, respectively). In this preferred embodiment, polarization filters 50a and 50b are arranged so as to face the pixels W1 and W2, respectively, and also have mutually different transmission axis directions. On the other hand, no polarization filter is provided for the pixel W3.

It should be noted that the arrangement of the respective members shown in FIG. 2 is only an example and the present invention is in no way limited to this specific example. Optionally, as long as the optical lens 3 can produce an image on the imaging area, the optical lens 3 may be arranged more distant from the image sensor 1 than the light-transmitting plate 2 is. Or multiple optical lenses may be arranged as well. Furthermore, the optical lens 3 and the light-transmitting plate 2 do not always have to be independent members but may be two integral parts that form a single optical element. Also, although the pixels W1, W2 and W3 are illustrated in FIG. 2 so as to be arranged in this order in X direction, which is parallel to the line segment that connects together the polarizing areas P(1) and P(2) of the light-transmitting plate 2, this arrangement does not always have to be taken. It should be noted that on the imaging area of the image sensor 1, a number of pixels are also arranged in the direction coming out of the paper on which FIG. 2 is drawn (i.e., in Y direction).

Hereinafter, the structure of the light-transmitting plate 2 and the arrangement of pixels in the solid-state image sensor 1 will be described in further detail. In the following description, the same coordinate system as what is shown in FIG. 2 will be used.

FIG. 3 is a front view of the light-transmitting plate 2 of this preferred embodiment. Just like the optical lens 3, the light-transmitting plate 2 also has a circular shape. In the light-transmitting plate 2, two polarizing areas P(1) and P(2) that have mutually different transmission axis directions are arranged in the X direction so as to be spaced apart from each other. The rest of the light-transmitting plate 2 other than those areas P(1) and P(2) is the transparent area P(3). When the light-transmitting plate is not rotated, the transmission axis direction of the polarizing area P(1) agrees with the X direction. On the other hand, the transmission axis direction of the polarizing area P(2) defines a tilt angle α (where 0 degrees<α≦90 degrees) with respect to the transmission axis direction of the polarizing area P(1).

The image capture device of this preferred embodiment can rotate the light-transmitting plate 2 using the rotation driving section 2A. If the angle of rotation of the light-transmitting plate 2 is θ (where 0 degrees≦θ<360 degrees), then the angle defined by the transmission axis of the polarizing area P(1) with respect to the X direction becomes θ. On the other hand, the angle defined by the transmission axis of the polarizing area P(2) with respect to the X direction becomes θ+α. The light-transmitting plate 2 has a circular shape in the example illustrated in FIG. 3 but does not always have to have a circular shape. The same can be said about the shape of the polarizing areas P(1) and P(2). That is to say, the polarizing areas P(1) and P(2) do not always have to have a rectangular shape but may have any other shape. Nevertheless, it is still preferred that the polarizing areas P(1) and P(2) have the same area and the same shape.

FIG. 4 illustrates a pixel block on the imaging area of the image sensor 1. As shown in FIG. 4, a number of pixels are arranged on the imaging area so that their basic unit consists of three pixels in three lines and one column. As described above, each basic unit of pixels consists of two pixels W1 and W2, for which two polarization filters 50a and 50b with mutually different polarization directions are provided, and one pixel W3, for which no polarization filters are provided at all. In each pixel block, W1, W2 and W3 are arranged along the Y-axis. As for the transmission axis directions of the polarization filters, the transmission axis of the polarization filter 50a that is located at the row 1, column 1 position defines a tilt angle γ (where 0 degrees≦γ≦90 degrees) with respect to the X direction, and the transmission axis of the polarization filter 50b that is located at the row 2, column 1 position defines a tilt angle γ+β (where 0 degrees<β≦90 degrees) with respect to the X direction.

Using such an arrangement, the respective pixels on the imaging area receive the light that has been transmitted through the polarizing areas P(1) and P(2) and the transparent area P(3) and then condensed by the optical lens 3. Hereinafter, it will be described how those pixels generate photoelectrically converted signals.

First of all, it will be described how the pixel W3 for which no polarization filters are provided generates a photoelectrically converted signal. The pixel W3 just receives the incoming light that has been transmitted through the light-transmitting plate 2, the optical lens 3 and the infrared cut filter 4 and outputs a photoelectrically converted signal representing the quantity of the incoming light received. Suppose the transmittance of the incoming light through the polarizing areas P(1) and P(2) of the light-transmitting plate 2 is identified by T1, and the respective levels of signals to be generated in a situation where the light that has been incident on the polarizing areas P(1) and P(2) and the transparent area P(3) is photoelectrically converted by the image sensor 1 without losing its intensity are identified by Ps(1), Ps(2) and Ps(3) with a subscript s added. In that case, the photoelectrically converted signal S3 generated by the pixel W3 is represented by the following Equation (1):

S3==T1(Ps(1)+Ps(2))+Ps(3) (1)

Next, it will be described how the pixels W1 and W2, for each of which a polarization filter is provided, generate a photoelectrically converted signal. Since the polarization filters 50a and 50b are arranged to face the pixels W1 and W2, respectively, basically the quantity of the light that strikes the pixels W1 and W2 is smaller than that of the light that strikes the pixel W3. Suppose the transmittance of non-polarized light through the polarization filter 50a or 50b is identified by T1 just like the transmittance of the polarizing areas P(1) and P(2), and the transmittance of polarized light, which oscillates in the transmission axis direction of each polarization filter, through that polarization filter is identified by T2. If the light-transmitting plate 2 is rotated θ degrees by the rotation driving section 2A, the levels of the photoelectrically converted signals S1 and S2 generated by the pixels W1 and W2 are represented by the following Equations (2) and (3), respectively:

S1=T1(T2(Ps(1)|cos(θ−γ)|+Ps(2)|cos(θ+α−γ)|)+Ps(3)) (2)

S2=T1(T2(Ps(1)|cos(θ−γ−β)|+Ps(2)|cos(θ+α−γ−β)|)+Ps(3)) (3)

In this case, if φ=θ−γ, Equations (2) and (3) can be modified into the following Equations (4) and (5), respectively:

S1=T1(T2(Ps(1)|cos φ|+Ps(2)|cos(φ+α)|)+Ps(3)) (4)

S2=T1(T2(Ps(1)|cos(φ−β)|+Ps(2)|cos(φ+α−β)|)+Ps(3)) (5)

where φ=θ−γ represents the relative angle of rotation of the light-transmitting plate 2 with respect to the transmission axis direction of the polarization filter 50a. By eliminating Ps(3) from these Equations (1), (4) and (5), Ps(1) and Ps(2) can be calculated by the following Equations (6) and (7), respectively:

$$\begin{matrix}Ps ( 1 ) = \frac{\begin{matrix}\begin{matrix}( \begin{matrix}T 2 \vert ( cos ( φ + α - β ) \vert \\ / T 1 - 1\end{matrix} ) {S}_{1} - \\ ( \begin{matrix}T 2 \vert ( cos ( φ + α ) \vert \\ / T 1 - 1\end{matrix} ) {S}_{2} +\end{matrix} \\ T 2 ( \begin{matrix}( \vert cos ( φ + α - β ) \vert - \\ \vert cos ( φ + α ) \vert ) {S}_{3}\end{matrix} ) {S}_{3} -\end{matrix}}{\vert D \vert} & ( 6 ) \\ Ps ( 2 ) = \frac{\begin{matrix}\begin{matrix}- ( \begin{matrix}T 2 \vert ( cos ( φ - β ) \vert \\ / T 1 - 1\end{matrix} ) {S}_{1} + \\ ( \begin{matrix}T 2 \vert ( cos φ \vert \\ / T 1 - 1\end{matrix} ) {S}_{2} -\end{matrix} \\ T 2 ( \begin{matrix}( \vert cos φ \vert - \\ \vert cos ( φ - β ) \vert\end{matrix} ) {S}_{3} -\end{matrix}}{\vert D \vert} & ( 7 )\end{matrix}$$

In Equations (6) and (7), their denominator |D| is a determinant represented by the following Equation (8):

$$\vert D \vert = \vert \begin{matrix}T 2 \vert cos φ \vert - T 1 & T 2 \vert cos ( φ + α ) \vert - T 1 \\ T 2 \vert cos ( φ - β ) \vert - T 1 & T 2 \vert cos ( φ + α - β ) \vert - T 1\end{matrix} \vert \qquad ( 8 )$$

According to these Equations (6) and (7), the image signals Ps(1) and Ps(2) represented by the light that has been transmitted through the polarizing areas P(1) and P(2) and then incident on the imaging area can be calculated based on S1, S2 and S3. Ps(1) and Ps(2) represent two images viewed from mutually different viewpoints. That is why by calculating their difference, information about the depth of the subject can be obtained. According to this preferred embodiment, the differential image is obtained as the difference between Ps(1) and Ps(2). In this description, a signal representing the differential image will be identified herein by Ds. On the other hand, the image signal Ps(3) represented by the light that has been transmitted through the transparent area can be obtained by substituting Ps(1) and Ps(2), which are given by Equations (6) and (7), respectively, into Equation (1).

As described above, the image capture device of this preferred embodiment can obtain multi-viewpoint images, a differential image and an ordinary image with no parallax. By rotating the light-transmitting plate 2 using the rotation driving section 2A, those images can be captured with the positions of the polarizing areas P(1) and P(2) and the magnitude of parallax both changed. And by performing the processing described above with the positions of the polarizing areas P(1) and P(2) changed, multiple pieces of parallax information can be obtained. As a result, compared to a situation where information about the depth of the subject is obtained by reference to only one piece of parallax information, the accurately of the subject's depth information can be increased.

If the value of the determinant |D| given by Equation (8) is zero, then the denominators of Ps(1) and Ps(2) given by Equations (6) and (7) also go zero, and therefore, neither Ps(1) nor Ps(2) can be obtained in that case. That is why the image capture device of this preferred embodiment sets the angle of rotation θ of the light-transmitting plate 2 so as to prevent the value of the determinant |D| given by Equation (8) from going zero.

Hereinafter, a preferred range of rotation of the light-transmitting plate 2 will be described. Supposing k=T1/T2 is satisfied, Equation (8) can be modified into the following Equation (9):

|D|=T2²{(|cos φ|−k)(|cos(φ+α−β)|−k)−(|cos(φ+α)|−k)(|cos(φ−β)|−k)} (9)

If every cos term of Equation (9) is positive, then the absolute value symbol can be removed with their signs unchanged. In that case, Equation (9) can be represented as the following Equation (10):

$$\begin{matrix}\vert D \vert = T {2}^{2} \{ ( cos φ - k ) ( cos ( φ + α - β ) - k ) - \\ ( cos ( φ + α ) - k ) ( cos ( φ - β ) - k ) \} \\ = T {2}^{2} \{ ( cos φcos ( φ + α - β ) - cos ( φ + α ) cos ( φ - β ) - \\ k ( cos φ - cos ( φ - β ) + cos ( φ + α - β ) - cos ( φ + α ) ) \\ = T {2}^{2} \{ ( cos ( α - β ) - cos ( α + β ) ) 2 + 2 k sin ( β / 2 ) \\ ( sin ( φ - β / 2 ) - sin ( φ + α - β / 2 ) ) \} \\ = T {2}^{2} \{ sin α sin β - 4 k sin ( β / 2 ) ( sin ( α / 2 ) \\ cos ( φ + ( α - β ) / 2 ) ) \}\end{matrix} \qquad ( 10 )$$

Equation (10) can be modified into the following Equation (11):

|D|=4T2² sin(α/2)sin(β/2){cos(α/2)cos(β/2)−k cos(φ+(α−β)/2)} (11)

On the other hand, if every cos term of Equation (9) is negative, then the absolute value symbol can be removed with their signs inverted. In that case, Equation (9) can be represented as the following Equation (12):

|D|=4T2² sin(α/2)sin(β/2){cos(α/2)cos(β/2)+k cos(φ+(α−β)/2)} (12)

The image capture device of this preferred embodiment satisfies 0 degrees<α≦90 degrees and 0 degrees<β≦90 degrees. That is why considering that the angle of rotation θ of the light-transmitting plate 2 is set to fall within the range of 0 degrees through 360 degrees, Equation (11) and (12) are always positive and never go zero as long as the following Inequality (13) is satisfied:

cos(α/2)cos(β/2)>k(=T1/T2) (13)

However, this Equation (13) is satisfied on the premise that the cos terms of Equation (9) are either all positive or all negative. More specifically, that premise is that cos φ, cos(φ+α), cos(φ−β) and cos(φ+α−β) are either all positive or all negative. That is why unless φ falls within the range of (90 degrees−α) through (90 degrees+β) or within the range of (270 degrees−α) through (270 degrees+β), the value of |D| represented by Equation (9) is always positive and never goes zero. In other words, as long as 0 degrees≦φ<90 degrees−α, 90 degrees+β<φ<270 degrees−α, or 270 degrees+β<φ<360 degrees is satisfied, the value of |D| is always positive and never goes zero.

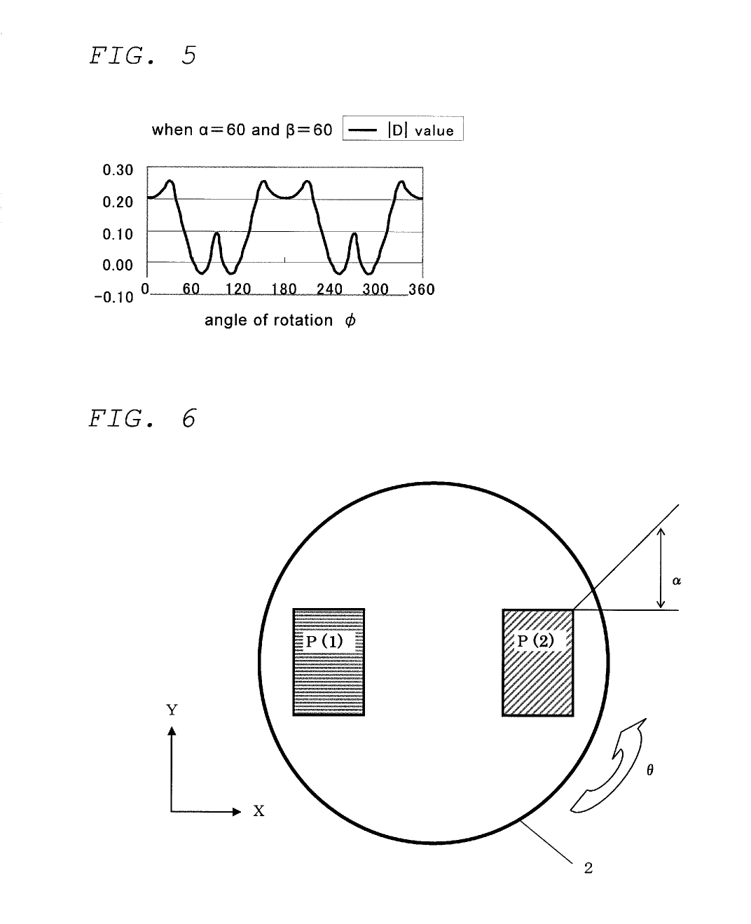

According to this preferred embodiment, the values of respective parameters T1, T2, α and β may be set to be equal to 0.45, 0.9, 60 degrees and 60 degrees, respectively. As γ does not appear in any of those equations, γ may have any value. In this example, γ=0 is supposed to be satisfied. Under these conditions, the left and right sides of Inequality (13) become equal to ¾ and ½, respectively, and therefore, Inequality (13) is met. FIG. 5 shows how much the |D| value depends on the angle φ in such a situation. As can be seen from FIG. 5, if φ falls within the range 0 degrees≦φ<30 degrees, 150 degrees<φ<210 degrees or 330 degrees<φ<360 degrees to say the least, multi-viewpoint images, a differential image and an ordinary image with no parallax can be obtained with no problem at all.

As described above, the image capture device of this preferred embodiment includes a light-transmitting plate that has two polarizing areas P(1) and P(2) and one transparent area P(3). Each pixel block on the imaging area of the image sensor 1 consists of two pixels W1 and W2, for which two polarization filters 50a and 50b with mutually different transmission axis directions are provided, and one pixel W3, for which no polarization filters are provided at all. Suppose the angle formed between the respective transmission axis directions of the polarizing areas P(1) and P(2) is α and the angle formed between the respective transmission axis directions of the polarization filters 50a and 50b is β. In that case, unless the difference φ between the angle of rotation θ of the light-transmitting plate 2 and the angle γ defined by the transmission axis of the polarization filter 50a with respect to the X direction falls within the range of (90 degrees−α) through (90 degrees+β) or within the range of (270 degrees−α) through (270 degrees+β), multi-viewpoint images, a differential image and an ordinary two-dimensional image with no parallax can be obtained. In particular, the smaller the polarizing areas P(1) and P(2), the more easily such a two-dimensional image that would cause no sensitivity problem can be obtained. In addition, by rotating the light-transmitting plate 2 so that the φ value falls within the permissible range described above and by calculating a differential image every time the light-transmitting plate 2 is rotated, information about the subject's depth can be obtained from a different viewpoint, which will increase the accuracy of the subject's depth information.

In the example described above, α=60 degrees and β=60 degrees are supposed to be satisfied. However, α and β do not always have to have this value. As long as the angles φ, α and β are set so as to satisfy 0 degrees≦φ<90 degrees−α, 90 degrees+β<φ<270 degrees−α, or 270 degrees+β<φ<360 degrees, then Inequality (13) will be met and multi-viewpoint images and a differential image can be obtained with no problem at all. Also, even if φ is set so as to fall within the range 90 degrees −α≦φ≦90 degrees+β or the range 270 degrees −α≦φ≦270 degrees+β, multi-viewpoint images and a differential image can be obtained without a problem unless the value of the determinant |D| represented by Equation (9) goes zero.

The rotation driving section 2A of the preferred embodiment described above operates in accordance with an instruction signal that has been received from the signal generating and image signal receiving section 5 by way of the sensor driving section 6. However, the present invention is in no way limited to that specific preferred embodiment. For example, the light-transmitting plate 2 may be rotated by manually turning the rotation driving section 2A.

In the preferred embodiment described above, a two-dimensional image that would cause no sensitivity problem is supposed to be obtained based on the light that has been transmitted through only the transparent area P(3) by making computations on the pixels. However, the present invention is in no way limited to that specific preferred embodiment. Alternatively, a two-dimensional image may also be obtained by using every one of the light rays that have been transmitted through the areas P(1), P(2) and P(3). In other words, a two-dimensional image may also be generated by synthesizing the signals Ps(1), Ps(2) and Ps(3) together.

Also, in the preferred embodiment described above, the light-transmitting plate 2 is supposed to have two polarizing areas (or polarizers). However, the light-transmitting plate 2 may also have three or more polarizing areas. Furthermore, the transmission axis direction of the polarizing area P(1) when θ=0 degrees does not have to agree with the X direction but may also be any other arbitrary direction.

Moreover, in the example illustrated in FIG. 4, the pixels W1, W2 and W3 are supposed to have a square shape and be arranged adjacent to each other in the Y direction. However, this is just an example of the present invention. Those pixels may have any other shape and the pixels W1, W2 and W3 do not have to be adjacent to each other in the Y direction. Nevertheless, it is still preferred that those pixels be arranged close to each other, to say the least.

In the image capture device of the preferred embodiment described above, light-transmitting plate 2 and the imaging area of the image sensor 1 are arranged parallel to each other as shown in FIG. 2. However, they don't always have to be arranged parallel to each other. Optionally, by interposing an optical element such as a mirror or a prism between them, the light-transmitting plate 2 and the imaging area of the image sensor 1 may also be arranged on two planes that intersect with each other. If such an arrangement is adopted, the angles α and β may be determined with respect to the transmission axis direction of the polarizing area P(1) in a situation where the light-transmitting plate 2 and the imaging area of the image sensor 1 are supposed to be parallel to each other with a change of the optical path due to the insertion of that optical element taken into account.

Furthermore, in the preferred embodiment described above, the image capture device is designed to obtain multi-viewpoint images, a differential image and an ordinary image at the same time. However, the present invention is in no way limited to that specific preferred embodiment. Optionally, the image capture device may also be designed to obtain only the multi-viewpoint images and the differential image without getting any ordinary image. If the image capture device is designed for such a purpose, there will be no need to provide the pixel W3 described above and the transparent area P(3) will be replaced with an opaque area that does not transmit light.

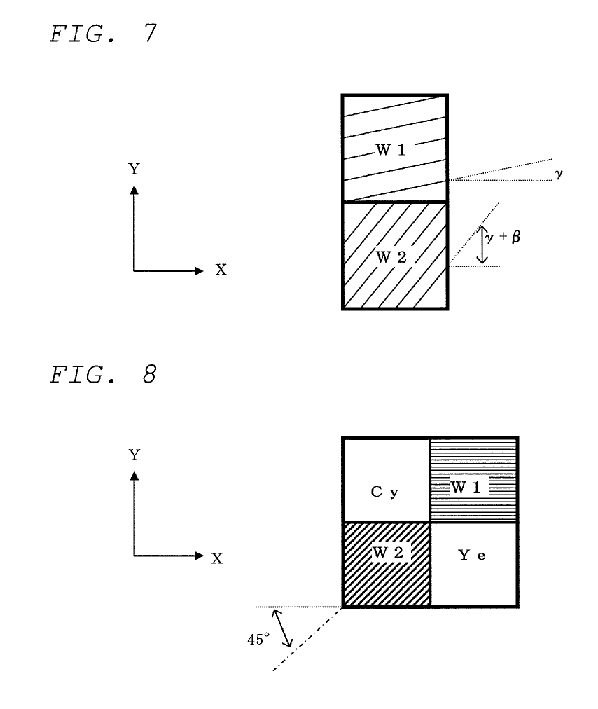

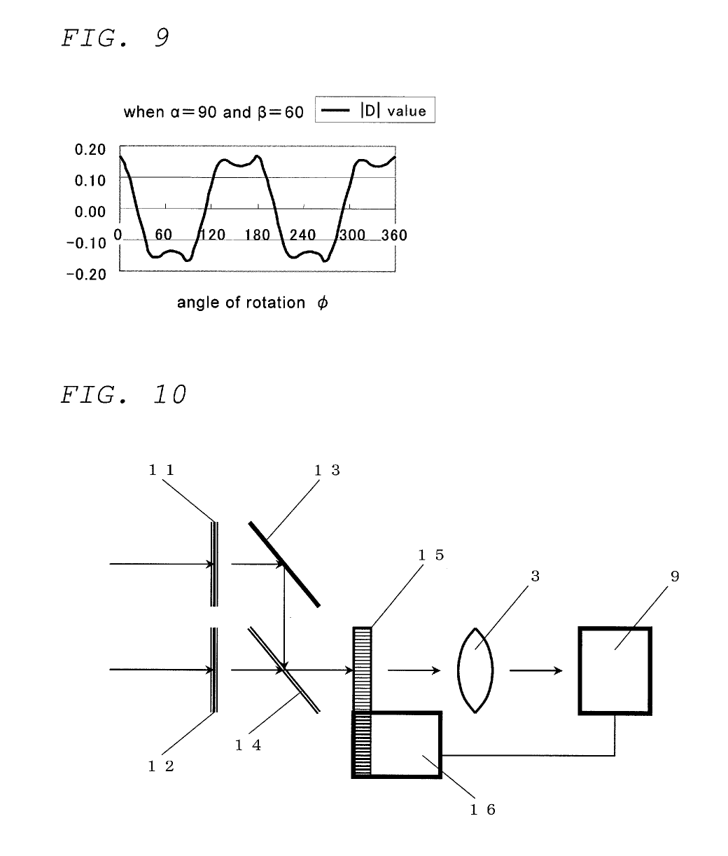

FIGS. 6 and 7 illustrate an exemplary structure of a light-transmitting plate 2 for an image capture device that obtains only multi-viewpoint images and a differential image without getting any ordinary image and a basic pixel arrangement, respectively. In that case, the rest of the light-transmitting plate 2 other than the polarizing areas P(1) and P(2) is an opaque area. Even in such an image capture device, the light-transmitting plate 2 can also be rotated on the optical axis by the rotation driving section 2A. On the other hand, on the imaging area of the image sensor 1, arranged are a number of pixel blocks, each of which consists of two pixels W1 and W2.

With such an arrangement adopted, the photoelectrically converted signals S1 and S2 that are output from those pixels W1 and W2 are calculated by the following Equations (14) and (15), respectively:

S1=T1T2(Ps(1)cos α+Ps(2)cos(α−θ)) (14)

S2=T1T2(Ps(1)cos β+Ps(2)cos((β−θ)) (15)

By modifying these Equations (14) and (15), Ps(1) and Ps(2) can be calculated by the following Equations (16) and (17), respectively:

$$\begin{matrix}Ps ( 1 ) = \frac{S 1 \vert cos ( θ + α - γ - β ) \vert - S 2 \vert cos ( θ + α - γ ) \vert}{T 1 T 2 \vert D \vert} & ( 16 ) \\ Ps ( 2 ) = \frac{- S 1 \vert cos ( θ - γ - β ) \vert + S 2 \vert cos ( θ - γ ) \vert}{T 1 T 2 \vert D \vert} & ( 17 )\end{matrix}$$

where |D| is a determinant given by the following Equation (18):

$$\vert D \vert = \vert \begin{matrix}\vert cos ( θ - γ ) \vert & \vert cos ( θ + α - γ ) \vert \\ \vert cos ( θ - γ - β ) \vert & \vert cos ( θ + α - γ - β ) \vert\end{matrix} \vert \qquad ( 18 )$$

Meanwhile, by calculating the difference between Ps(1) and Ps(2), the differential image Ds can be given by the following Equation (19):

$$Ds = \frac{\begin{matrix}S 1 \{ \begin{matrix}\vert cos ( θ + α - γ - β \vert + \\ \vert cos ( θ - γ - β ) \vert\end{matrix} \} - \\ S 2 \{ \begin{matrix}\vert cos ( θ + α - γ ) \vert + \\ \vert cos ( θ - γ ) \vert\end{matrix} \}\end{matrix}}{T 1 T 2 \vert D \vert} \qquad ( 19 )$$

As indicated by Equations (16) through (19), the signals Ps(1) and Ps(2) and the signal Ds representing the differential image can be obtained based on the photoelectrically converted signals S1 and S2 provided by the pixels W1 and W2. If the respective images with parallax are obtained by using such an arrangement, the angles θ, α, β and γ are preferably set so as to prevent the value of the determinant |D| of Equation (18) from going zero. Such an image capture device can also obtain multiple pairs of multi-viewpoint images by capturing images with the angle of rotation θ of the light-transmitting plate 2 changed.

### Embodiment 2

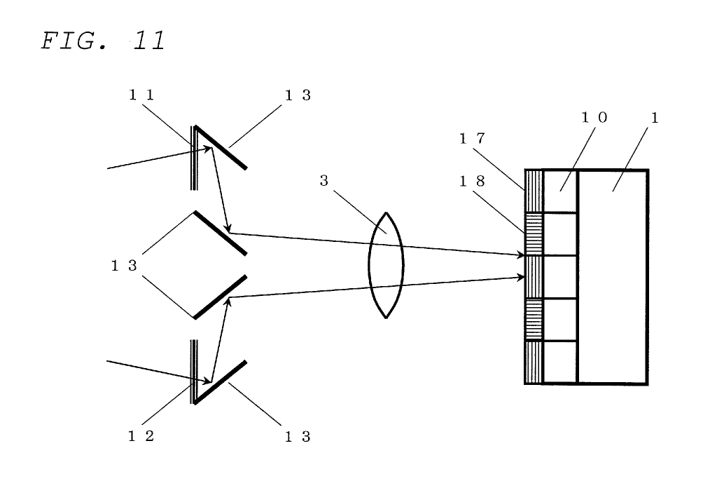

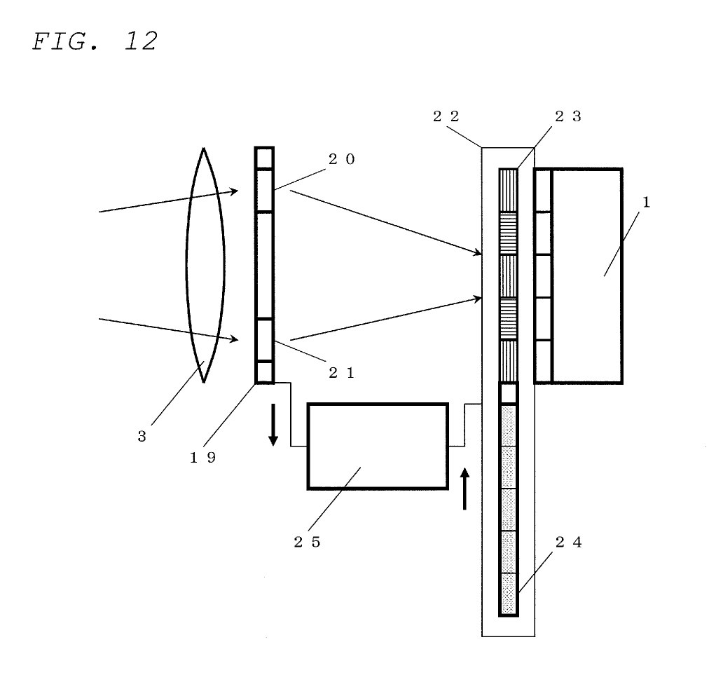

Hereinafter, a second preferred embodiment of the present invention will be described with reference to FIGS. 8 and 9. The image capture device of this preferred embodiment adopts a different basic arrangement of pixels for its image sensor 1 and uses a different method for obtaining images with parallax from its counterpart of the first preferred embodiment described above. Thus, the following description of the second preferred embodiment will be focused on only those differences from the image capture device of the first preferred embodiment and description of their common features will be omitted.

FIG. 8 illustrates a basic arrangement of pixels on the imaging area of the solid-state image sensor 1 of this preferred embodiment. In this preferred embodiment, the basic arrangement of pixels is a pixel block consisting of four pixels that are arranged in two columns and two rows, and either color elements (color filters) or polarization filters are arranged so as to face their associated pixels. The color elements of this preferred embodiment are known color filters, which transmit only color components falling within particular wavelength ranges. In the following description, a color filter that transmits only light with a color component C will be referred to herein as a “C element”, for example.

As for color elements, a cyan element Cy is arranged so as to face the pixel at the row 1, column 1 position, a yellow element Ye is arranged so as to face the pixel at the row 2, column 2 position, but no color elements are arranged to face the pixel at the row 1, column 2 position or at the row 2, column 1 position. Instead, a polarization filter, of which the transmission axis direction agrees with the X direction, is arranged to face the pixel at the row 1, column 2 position. And a polarization filter, of which the transmission axis direction defines an angle of 45 degrees with respect to the X direction, is arranged to face the pixel at the row 2, column 1 position. This pixel arrangement forms a square matrix, and therefore, the line segment that connects together the respective centers of the two polarization filters, which are arranged to face the two pixels W1 and W2, defines an angle of 45 degrees with respect to the X direction.

On the other hand, the light-transmitting plate 2 has the same shape as its counterpart of the first preferred embodiment described above. According to this preferred embodiment, however, the angle formed between the respective transmission axes of the polarizing areas P(1) and P(2) is set to be 90 degrees. That is to say, according to this preferred embodiment, α=90 degrees, β=45 degrees, γ=0 degrees and θ=φ. Also, T1=0.45 and T2=0.9 are supposed to be satisfied.

The image capture device of this preferred embodiment gets the light-transmitting plate 2 rotated by the rotation driving section 2A with the angle φ1 set to be an arbitrary value, captures images when φ=φ1 and when φ=φ1+180 degrees, and gets the computational processing of the first preferred embodiment done. For example, the image capture device may capture those images when φ=0 degrees and when φ=180 degrees, thereby obtaining multi-viewpoint images and a differential image in each of those two situations. According to this preferred embodiment, the images may sometimes be captured at an angle of rotation that falls out of the permissible range of rotation as described for the first preferred embodiment. However, even if the angle of rotation fell out of that permissible range of rotation, there should be no problem as long as α, β and φ are set such that the value of |D| given by Equation (9) does not go zero. The conditions that have been imposed on α, β and φ in the first preferred embodiment described above (i.e., 0 degrees≦φ<90 degrees−α, 90 degrees+β<φ<270 degrees−α, and 270 degrees+β<φ<360 degrees) guarantees that the value of |D| given by Equation (9) does not go zero. That is why even if the angle of rotation is outside of the permissible range, the value of |D| could be unequal to zero.

The image capture device of this preferred embodiment has the following three major features. First of all, there is no pixel W3 unlike the first preferred embodiment described above. Secondly, the respective transmission axes of the polarizing areas P(1) and P(2) cross each other at right angles in order to capture images when φ=φ1 and when φ=φ1+180 degrees by rotating the light-transmitting plate 2. Thirdly, the image sensor of this preferred embodiment can make a color representation.

To begin with, the first major feature will be described. Since the pixel W3 of the first preferred embodiment is absent from the pixel arrangement shown in FIG. 8, the calculations that have been described for the first preferred embodiment should be not applicable to such a situation in principle. However, if a subject in almost an achromatic color is captured, Cy+Ye=W+G is satisfied. That is why if the RGB photodetector signal ratio is represented by Kr, Kg and Kb, a signal corresponding to the pixel signal S3 supplied from the pixel W3 should be obtained by multiplying the sum Scy+Sye of the signals generated through the Cy and Ye elements by (Kr+Kg+Kb)/(Kr+2Kg+Kb). Thus, the signal corresponding to the pixel signal S3 is obtained by making such a calculation. Then, unless the value of |D| given by Equation (9) is zero, multi-viewpoint images and a differential image can be generated by performing the same processing as in the first preferred embodiment. It should be noted that those photodetector signal ratio Kr, Kg and Kb are stored in advance as internal parameters of the image capture device in a storage medium in the image capture device.

Next, the second major feature of this preferred embodiment will be described. FIG. 9 shows how much the |D| value depends on the angle of rotation θ (=φ) of the light-transmitting plate of this preferred embodiment. As can be seen from FIG. 9, even if the light-transmitting plate 2 is rotated so that φ becomes equal to 0 degrees or 180 degrees, for example, the |D| value still does not go zero. In another example, even if the light-transmitting plate 2 is rotated so that φ becomes equal to 150 degrees or 330 degrees, the |D| value still does not go zero, either. That is to say, if the |D| value does not go zero even when φ=φ1 or when φ=φ1+180 degrees, the computational processing of the first preferred embodiment described above can get done in both of those two situations. As a result, images represented by the light rays that have been incident on the polarizing areas P(1), P(2) and P(3) can be calculated.

According to this preferred embodiment, as for the image signals Ps(1) and Ps(2) represented by the light rays that have been incident on the polarizing areas P(1) and P(2), respectively, the differential image is obtained based on two sets of data collected by capturing images when φ=φ1 and when φ=φ1+180 degrees. In this processing, the square of the image signal Ps(1) when φ=φ1 and the square of the image signal Ps(2) when 0=φ1+180 degrees are added together, and the sum is subjected to root processing, thereby getting a first piece of image information. In the same way, the square of the image signal Ps(2) when φ=φ1 and the square of the image signal Ps(1) when φ=φ1+180 degrees are also added together, and the sum is subjected to root processing, thereby getting a second piece of image information. The image Ps(1) when φ=φ1 and the image Ps(2) when φ=φ1+180 degrees respectively correspond to an image with a zero degree polarization property and an image with a 90 degree polarization property that have been observed at the same position. That is why if a subject with polarization properties is shot, the polarization properties of the subject can be canceled through the processing described above. Normally, a subject with polarization properties is shot with filters that cross each other at right angles and the sum of the squares of their polarization components is calculated, thereby measuring the optical energy of the subject. For that reason, similar processing is carried out in this preferred embodiment, too.

The third major feature of this preferred embodiment will be described. As for a color image, suppose a signal generated by photoelectrically converting a light ray that has been transmitted through the cyan element is identified by Scy. A signal generated by photoelectrically converting a light ray that has been transmitted through the yellow element is identified by Sye. And the sum of two photoelectrically converted signals of the pixels W1 and W2 is identified by Sw. In that case, information Sr about the color red is obtained by calculating (Sw−Scy). Information Sb about the color blue is obtained by calculating (Sw−Sye). And information about the color green is obtained by calculating (Sw−Sr−Sb). As a result, the quantity of the light decreases only in the polarizing areas P(1) and P(2) of the light-transmitting plate 2, and therefore, a color image can obtained with a significantly lower percentage of the incoming light lost.

As described above, according to this preferred embodiment, first of all, images are captured in a situation where φ=φ1 and in a situation where φ=φ1+180 degrees with the respective transmission axes of the polarizing areas P(1) and P(2) crossed each other at right angles and with the angle φ1 set to be an arbitrary value. Secondly, pixels are arranged on the imaging area of the solid-state image sensor 1 so that each basic pixel arrangement consists of four pixels in two columns and two rows. A cyan element Cy is arranged to face the pixel at the row 1, column 1 position. A yellow element Ye is arranged to face the pixel at the row 2, column 2 position. A polarization filter, of which the transmission axis direction agrees with the X direction (i.e., γ=0), is arranged to face the pixel at the row 1, column 2 position. And a polarization filter, of which the transmission axis defines an angle of 45 degrees (i.e., β=45 degrees) with respect to the X direction, is arranged to face the pixel at the row 2, column 1 position. By adopting such an arrangement and by rotating the light-transmitting plate with the rotation driving section 2A, multi-viewpoint images, a differential image and a color image can still be obtained even if the subject has polarization properties. It should be noted that by setting the size of the polarizing areas P(1) and P(2) to be much smaller than that of the transparent area P(3), a color image can be obtained with the decrease in sensitivity minimized.

In the example described above, specified are specific values of the parameters γ and β that define the transmission axis directions of the polarization filters and the transmittances T1 and T2 of the polarizing areas. However, this is just an example of the present invention. The preferred embodiment of the present invention described above may be modified in any other way as long as the value of |D| given by Equation (9) does not go zero, the respective transmission axes of the two polarizing areas P(1) and P(2) cross each other at right angles, and the light-transmitting plate is rotated so as to capture images at each of the angles φ1 and φ1+180 degrees.

Also, the color filters of this preferred embodiment do not always have to be cyan and yellow elements. Speaking more generally, two kinds of color filters, one of which transmits a first-color component and the other of which transmits a second-color component, just need to be arranged there. For example, an arrangement for obtaining a red signal and a blue signal directly as pixel signals by using a red element and a blue element as color filters may be adopted.

In the preferred embodiment described above, the transmission axis of the polarizing area P(2) is supposed to define an angle α of 90 degrees with respect to the transmission axis of the polarizing area P(1). However, a does not have to be exactly equal to 90 degrees but may be slightly different from it. α is set preferably to satisfy 70 degrees≦α≦90 degrees, and more preferably to satisfy 80 degrees≦α≦90 degrees. Also, according to the present invention, α=90 degrees is not always satisfied. Rather, even if α≠90 degrees, parallax information can still be obtained by Equations (6) and (7).

Furthermore, pixels do not always have to be arranged to form such a square matrix. And none of those pixels have to have a square shape, either. Rather, the effects of this preferred embodiment can be achieved as long as each pixel block consists of four pixels, two of which face polarization filters with mutually different transmission axis directions and the other two of which face filters in two different colors.

Optionally, the pixel arrangement shown in FIG. 8 may be replaced with a different pixel arrangement. For example, even if the pixel arrangement shown in FIG. 4 or 7 is adopted, multi-viewpoint images and a differential image can also be obtained from a subject with polarization properties by capturing those images in two states in which the angles of rotation of the light-transmitting plate 2 are different from each other by 180 degrees.

The first and second preferred embodiments of the image capture device of the present invention described above may be modified so as to obtain either the multi-viewpoint images or the differential image. For example, the image capture device may obtain only the multi-viewpoint images and the differential image may be obtained by another computer that is either hardwired or connected wirelessly to the image capture device. Still alternatively, the image capture device may obtain only the differential image and another device may obtain the multi-viewpoint images.

Furthermore, in the first and second preferred embodiments of the present invention described above, the image capture device may also obtain a so-called “disparity map”, which is a parallax image representing the magnitude of shift in position between each pair of associated points on the images, based on the multi-viewpoint images. By getting such a disparity map, information indicating the depth of the subject can be obtained.

### INDUSTRIAL APPLICABILITY

The 3D image capture device of the present invention can be used effectively in every camera that uses a solid-state image sensor, and can be used particularly effectively in digital still cameras, digital camcorders and other consumer electronic cameras and in industrial solid-state surveillance cameras, to name just a few.

### REFERENCE SIGNS LIST

1 solid-state image sensor
2 light-transmitting plate 2A rotation driving section
3 optical lens
4 infrared cut filter
5 signal generating and image signal receiving section
6 sensor driving section
7 image processing section
8 image interface section
9 image capture device
10 pixel
11 0-degree-polarization polarizer
12 90-degree-polarization polarizer
13 reflective mirror
14 half mirror
15 circular polarization filter
16 driver that rotates polarization filter
17, 18 polarization filter
19 light transmitting section
20, 21 polarized light transmitting section
22 light receiving member optical filter tray
23 particular component transmitting filter
24 color filter
25 filter driving section
50a, 50b polarization filter

1. A 3D image capture device comprising:
a light transmitting section with at least two polarizers;
a solid-state image sensor that receives the light ray that has been transmitted through the light transmitting section;
an imaging section that produces an image on an imaging area of the solid-state image sensor; and
a rotation driving section that rotates the light transmitting section on the optical axis of incoming light,
wherein the light transmitting section includes
a first polarizer, and
a second polarizer, of which the transmission axis defines an angle α (where 0 degrees<α≦90 degrees) with respect to the transmission axis of the first polarizer, and
wherein the solid-state image sensor includes
a number of pixel blocks, each of which includes first and second pixels,
a first polarization filter that is arranged to face the first pixel of each said pixel block, and
a second polarization filter that is arranged to face the second pixel of each said pixel block and of which the transmission axis defines an angle β (where 0 degrees<β≦90 degrees) with respect to the transmission axis of the first polarization filter, and
wherein the first polarization filter is arranged so as to receive the light rays that have been transmitted through the first and second polarizers, and
the second polarization filter is also arranged so as to receive the light rays that have been transmitted through the first and second polarizers.

2. The 3D image capture device of claim 1, wherein the light transmitting section has a transparent area that always transmits incoming light irrespective of its polarization direction, and
wherein each said pixel block further has a third pixel, and
wherein the third pixel receives the light rays that have been transmitted through the first and second polarizers and the transparent area, respectively, and outputs a photoelectrically converted signal representing the quantity of the light received.

3. The 3D image capture device of claim 2, wherein if a transmittance when non-polarized light is incident on the first and second polarizers and the first and second polarization filters is T1, and
if a transmittance when polarized light that oscillates along the transmission axis of the first polarization filter is incident on the first polarization filter and a transmittance when polarized light that oscillates along the transmission axis of the second polarization filter is incident on the second polarization filter are T2, and
if the angle defined by the transmission axis of the first polarizer with respect to the transmission axis of the first polarization filter is φ,
then the angle of rotation of the light transmitting section is set such that the value of the determinant
$$\vert D \vert = \vert \begin{matrix}T 2 \vert cos φ \vert - T 1 & T 2 \vert cos ( φ + α ) \vert - T 1 \\ T 2 \vert cos ( φ - β ) \vert - T 1 & T 2 \vert cos ( φ + α - β ) \vert - T 1\end{matrix} \vert$$
does not become equal to zero.

4. The 3D image capture device of claim 3, wherein the inequality
cos(α/2)cos(β/2)>T1/T2
is satisfied, and
wherein φ is defined to fall within one of the three ranges of: 0≦φ<π/2−α, π/2+β<φ<3π/2−α, and 3π/2+β<φ2π.

5. The 3D image capture device of claim 1, wherein 80 degrees≦α≦90 degrees is satisfied.

6. The 3D image capture device of claim 2, wherein each said pixel block further includes a fourth pixel, and
wherein the solid-state image sensor includes
a first color filter that is arranged so as to face the third pixel of each said pixel block and to transmit a light ray representing a first color component, and
a second color filter that is arranged so as to face the fourth pixel of each said pixel block and to transmit a light ray representing a second color component.

7. The 3D image capture device of claim 6, wherein in each said pixel block, the first, second, third and fourth pixels are arranged in matrix, in which the first pixel is arranged at a row 1, column 1 position, the second pixel is arranged at a row 2, column 2 position, the third pixel is arranged at a row 1, column 2 position, and the fourth pixel is arranged at a row 2, column 1 position.

8. The 3D image capture device of claim 6, wherein one of the first and second color filters transmits a light ray representing a yellow component, while the other color filter transmits a light ray representing a cyan component.

9. The 3D image capture device of claim 1, wherein if the angle defined by the transmission axis of the first polarizer with respect to the transmission axis of the first polarization filter is φ,
the device captures an image in each of a first state in which φ=φ1 (where 0 degrees≦1<360 degrees) and a second state in which φ=φ1+180 degrees.

10. The 3D image capture device of claim 1, further comprising an image processing section that generates an image representing the difference between two images with parallax using photoelectrically converted signals supplied from the first and second pixels.

11. An image generating method for use in a 3D image capture device,
the device comprising: a light transmitting section with first and second polarizers; a solid-state image sensor that receives the light ray that has been transmitted through the light transmitting section; and a rotation driving section that rotates the light transmitting section on the optical axis of incoming light,
wherein the transmission axis of the second polarizer defines an angle α (where 0 degrees<α≦90 degrees) with respect to the transmission axis of the first polarizer, and
wherein the solid-state image sensor includes
first and second pixels,
a first polarization filter that is arranged to face the first pixel, and
a second polarization filter that is arranged to face the second pixel and of which the transmission axis defines an angle β (where 0 degrees<β≦90 degrees) with respect to the transmission axis of the first polarization filter, and
wherein the method comprises the steps of:
getting a first photoelectrically converted signal from the first pixel;
getting a second photoelectrically converted signal from the second pixel; and
generating an image representing the difference between two images with parallax based on the first and second photoelectrically converted signals.
